(19) United States
(12) Patent Application Publication
(10) Pub. No.: US 2004/0244001 A1
(43) Pub. Date: Dec. 2, 2004

(54) Methods of allocating use of multiple resources in a system

(76) Inventors: John Henry Haller, Naperville, IL (US); Steven Hunter, Malmesbury (GB); Michael John Lemke, Plainfield, IL (US); Kevin Wayne McKiou, Naperville, IL (US); Harvey Rubin, Township of Morris, NJ (US); Brian Tickle, Naperville, IL (US)

Correspondence Address: HARNESS, DICKEY & PIERCE, P.L.C., P.O. Box 8910, Reston, VA, 20195, US

(21) Appl. No.: 10/448,045

(22) Filed: May 30, 2003

(51) Int. Cl. G06F 9/46

(52) U.S. Cl. 718/100

(57) ABSTRACT

A method allowing a plurality of resources allocators to allocate use of resources (e.g., processing resources) without communicating with each other. The resource allocators are independent of one another and allocate the resources based upon availability notifications from a plurality of resources. Availability of a resource is based upon a characteristic of the resource (e.g., resource occupancy) and may be determined by the resource comparing the characteristic to a threshold.

### BACKGROUND OF THE INVENTION

In systems, for example computer systems, multiple resources (e.g., processing resources, coding resources, etc.) are typically available. The multiple resources further may be organized within a sub-system of distributed processors. When a system receives a stimulus to perform work (e.g., request for processor action), a resource allocator in the system assigns a resource to the work item. The resource allocator is usually designed to try to balance the load across the resources in order to reduce or eliminate performance bottlenecks when other resources are available to handle the workload. Therefore, the resource allocator is usually designed to keep track of the current utilization of the available resources.

Additionally, to reduce or eliminate the likelihood that the resource allocator itself does not become a performance bottleneck in the system, and to provide continued operation of the system in the event that the resource allocator fails, multiple resource allocators are typically provided as part of the system. Thus, the system contains multiple resource allocators allocating work to multiple resources.

One problem that arises when multiple resource allocators are used in a system is the need to synchronize the allocation of resources by these resource allocators. If the allocation of resources by these resource allocators is not synchronized, extreme imbalance may occur in the workload of the available resources. In such a system, the typical method for achieving the required synchronization is for the resource allocators to communicate between themselves to exchange information about the use of resources each allocated since the last inter-allocator communication. Other methods are also known wherein each resource communicates to each resource allocator when its load is increased or decreased (e.g., when a new job is assigned to it and when an existing job is completed). Thus, as shown in FIG. 1, a system 20 includes multiple resources allocators 22 communicating between each other, as well as communicating with multiple resources 24 to allocate work to the multiple resources 24.

A disadvantage of these known methods is the introduction of a significant amount of communications in and to the system that are not related to the actual performance of the processing by the resources, but are only related to exchanging of information relating to the current workload of the available resources. Depending on the specific design, these methods can lead to significant capacity inefficiencies of the resources and/or of the resource allocators.

### SUMMARY OF THE INVENTION

Various embodiments of the present invention provide a method allowing a plurality of resources allocators to allocate resources (e.g., use of processing resources, coding resources, etc.) without communicating with each other. The resource allocators are independent of one another and allocate the resources based upon availability notifications from a plurality of resources. Availability of a resource is based upon a characteristic of the resource (e.g., resource occupancy) and may be determined by the resource comparing the characteristic to a threshold.

Specifically, in one embodiment of the present invention, a method for resource availability notification includes first generating a notification of resource availability based on a characteristic of the resource. The method further may include comparing the characteristic to a first threshold, where the first generating step for generating a notification of resource availability is based on results of the comparison. A determination then may be made as to when the characteristic falls below the first threshold, with the first generating step generating the availability notification in response to the determination. Generating a second notification of resource unavailability based on a comparison of the characteristic to a second threshold, and in particular when the characteristic exceeds the second threshold, also may be provided.

In another embodiment of the present invention, a method for allocating use of resources in a system includes allocating use of a plurality of resources based upon a notification received from one or more of the plurality of resources of an availability of the one or more resources. The method also may include assigning different resources to perform operations based upon the availability and storing an availability indication for each notification received from one or more of the plurality of resources.

### BRIEF DESCRIPTION OF THE DRAWINGS

Exemplary embodiments of the present invention will become more fully understood from the detailed description given hereinbelow and the accompanying drawings:

FIG. 1 is a block diagram illustrating a prior art system for use in allocating a plurality of resources;

FIGS. 2A-2C are block diagrams illustrating various embodiments of a system of the present invention for allocating use of a plurality of resources;

FIG. 3 is a flow chart of one exemplary embodiment of a method of the present invention for allocating use of a plurality of resources;

FIG. 4 is a block diagram of an exemplary wireless communication system in connection with which various embodiments of the present invention may be implemented;

FIG. 5 is a block diagram of an exemplary wireless network with cell sites dedicated to controllers and in connection with which various embodiments of the present invention may be implemented; and

FIG. 6 is a block diagram of an exemplary wireless network with cell sites not dedicated to controllers and in connection with which various embodiments of the present invention may be implemented.

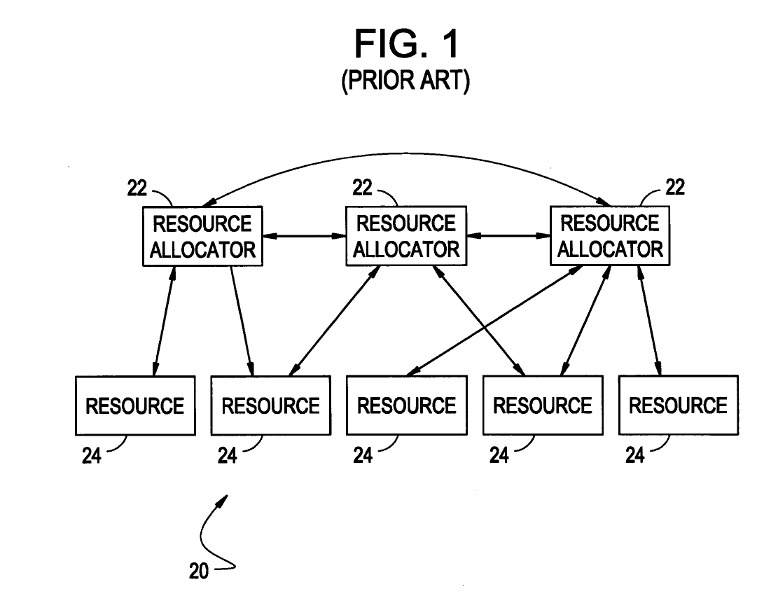

### DETAILED DESCRIPTION OF EXEMPLARY EMBODIMENTS

The following description of the exemplary embodiments is merely exemplary in nature and is in no way intended to limit the invention, its application, or uses. Although the various embodiments of present invention are described in connection with systems having specific component parts and particular requirements, they are not so limited, and the various embodiments of the present invention may be provided in connection with different systems having different component parts and/or requirements.

A general description of systems that may be provided in connection with various embodiments of the present invention will first be provided. A detailed description of various embodiments of the present invention will follow.

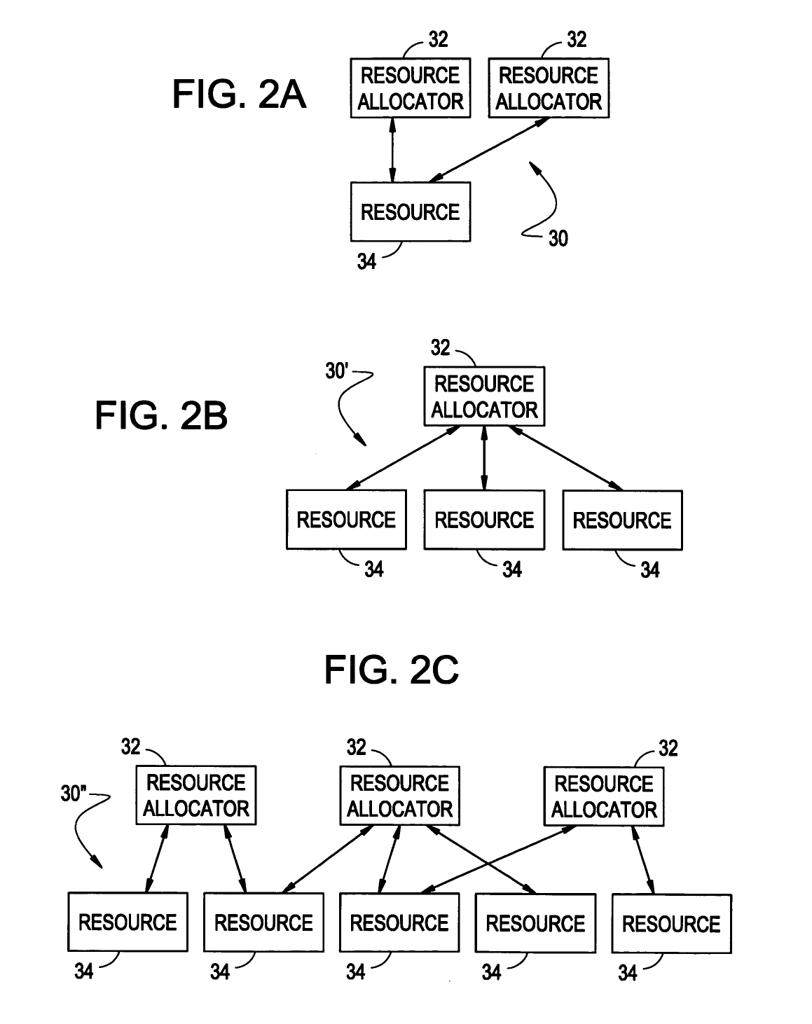

As shown in FIGS. 2A-2C, exemplary systems 30, 30′, 30″ (e.g., computer systems) that may be provided in connection with the present invention include one or more resource allocators 32 for allocating use of one or more resources 34 (e.g., processing resources, coding resources, etc.). In particular, and referring to the system 30 shown in FIG. 2A, a plurality of resource allocators 32 may be provided in connection with a single resource 34 for controlling allocation of jobs (e.g., processing jobs, coding jobs, etc.) to that resource 34. As shown in FIG. 2B, a system 30′ may include a single resource allocator 32 in connection with a plurality of resources 34 for controlling allocation of jobs to the plurality of resources 34. Further, as shown in FIG. 2C, a system 30″ may include a plurality of resource allocators 32 in connection with a plurality of resources 34 for controlling allocation of jobs to the plurality of resources 34.

Each resource 34 has one or more characteristics that may be used to measure the performance of the resource 34. For example, the performance of the resource 34 may be measured by the level of use of the capabilities of the resource 34 (e.g., amount of processing capacity being used). Further, these characteristics include, but are not limited to, resource occupancy, which may include the amount of resource memory or resource processing being used, the number of work items or jobs being handled by the resource 34, the number of operations being performed by the resource 34, and input/output (I/O) delay or throughput for the resource 34, among others. Also, the characteristic may be a current calculated or monitored characteristic for the resource 34, or may be an anticipated characteristic, for example, based upon the number of jobs currently being performed. Further, each resource 34 is assigned to one or more of the plurality of resource allocators 32. In operation, the one or more resource allocators 32 to which the resource 34 is assigned may allocate use of that resource 34 (e.g., send a job to be performed). For example, the resource allocators 32 may maintain a list of the addresses (e.g., in memory) of the resources 34 to which it can allocate jobs or system operations.

It should be noted that where reference is made herein to a resource allocator 32, this refers to any device (e.g., computer or server) or program (e.g., software application) for allocating jobs or other system operations to components or programs within a system. When reference is made herein to a resource 34, this refers to any device or program within a system capable of performing jobs or other system operations within the system.

It should also be noted that within a system, different resource allocators 32 may be connected to or communicating with the same or different resources 34. Further, and as described in more detail below, the different resource allocators 32 do not need to communicate with each other in order to allocate use of the plurality of resources 34. Further, the resource allocators 32 do not need to monitor or keep track of the workload of each of the resources 34.

Having described exemplary systems that may be provided in connection with various embodiments of the present invention, methods for allocating resources 34 and for providing resource availability notification will now be described. The various embodiments may be provided in connection with the systems 30, 30′, 30″ or any other system requiring allocation of resources 34.

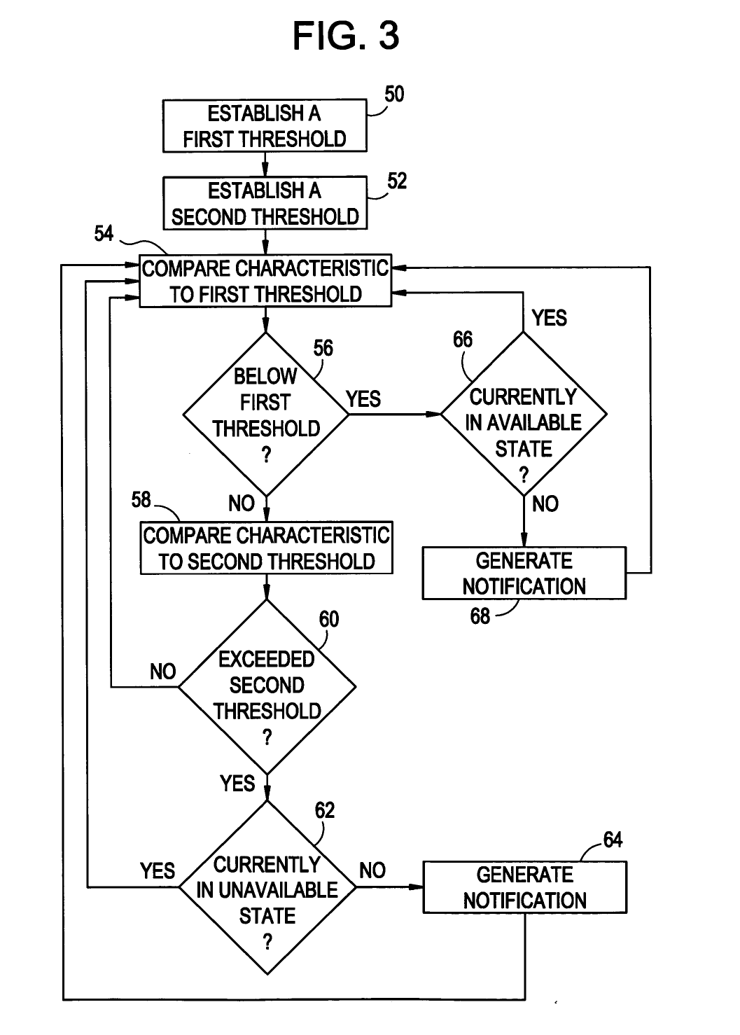

Specifically, and referring to FIG. 3 showing an exemplary embodiment of a method of the present invention for use in allocating the resources 34, a first threshold (e.g., predetermined level of resource occupancy) for one or more of the resources 34 is established at step 50. A second threshold (e.g., predetermined level of resource occupancy) for one or more of the resources is established at step 52. The first and second thresholds may be the same or different for each of the plurality of resources 34. Thus, the first and second thresholds established at steps 50 and 52 are assigned to each of the plurality of resources 34.

It should be noted that the first and second thresholds for a particular resource 34 may be different values or may be the same value. Further the first and second thresholds may be related to, for example, system requirements or operating conditions, such as use of processing cycles, use of I/O bandwidth or delay. In one embodiment, the first and second thresholds may be allocated to the resources 34, for example by a management system, with threshold values calculated for a characteristic of a resource 34 by the resource 34 when it starts up, or the threshold values may be hard-coded for the resource 34.

Thereafter, and referring again to FIG. 3, at step 54, a resource 34 compares one of its characteristics to the first threshold. A first determination of the availability of the resource 34 is then made based upon the results of the comparison. Specifically, and in this exemplary method, a first determination is then made at step 56 as to whether the characteristic has fallen below the first threshold based upon the comparison (e.g., whether resource occupancy has fallen below a predetermined level). If the characteristic has not fallen below the first threshold, then the resource 34 compares the same characteristic to a second threshold at step 58. A second determination of the availability of the resource 34 is then made based upon the results of the comparison. Specifically, and in this exemplary method, a second determination is then made at step 60 as to whether the characteristic has exceeded the second threshold. If the characteristic has exceeded the second threshold, a determination is made at step 62 as to whether the resource 34 is currently unavailable (i.e., in an unavailable state). If the resource 34 is currently unavailable, then a comparison of the characteristic to the first threshold is again made at step 54. If the resource is currently not unavailable (i.e., in an available state) then at step 64 an unavailability notification is generated indicating that the resource 34 is unavailable for use (e.g., cannot handle additional jobs). The unavailability notification is transmitted to one or more of the resource allocators 32 to which the resource 34 is assigned. Thereafter, or if at step 60 a determination is made that the second threshold has not been exceeded, a comparison of the characteristic to the first threshold is again made at step 54.

Referring again to step 56, if a first determination is made that the characteristic has fallen below the first threshold, then a determination is made at step 66 as to whether the resource 34 is currently available (i.e., in an available state). If the resource 34 is currently available, then a comparison of the characteristic to the first threshold is again made at step 54. If the resource is currently unavailable (i.e., in an unavailable state) then at step 68 an availability notification is generated indicating that the resource 34 is available for use (e.g., can handle additional jobs). The availability notification is transmitted to one or more of the resource allocators 32 to which the resource 34 is assigned. Thereafter, a comparison of the characteristic to the first threshold is again made at step 54.

It should be noted that the order of the steps performed in the method illustrated in FIG. 3 is merely exemplary of one embodiment of the present invention. For example, a determination of whether the characteristic exceeds the second threshold may be made before a determination of whether the characteristic falls below the first threshold. Further, it should be noted that the comparison at step 54 may be performed on a continuous basis, at predetermined intervals or at predetermined periods of time. For example, the comparison may be made when a resource 34 completes a process or job, or when memory utilization for the resource 34 reaches a predetermined level. Additionally, a characteristic may be, for example, a calculated processor occupancy based on the number of jobs being run. Alternately, a characteristic may be the amount of memory or I/O bandwidth anticipated to be used based on the number of jobs being performed by a resource 34. The determination of these types of characteristics may be made at discrete points in time when a job is started and/or when a job ends. A characteristic also may be, for example, dynamic memory usage, or I/O delay or throughput. In such instances, and for example, a program (e.g., software program) providing memory allocation or I/O control may continually monitor a characteristic and interrupt the processor when a threshold is reached and/or crossed.

Thus, in operation, the resource allocators 32 allocate use of the resources 34 based upon the availability and unavailability notifications received from the resources 34. Specifically, if the characteristic (e.g., workload) of a resource 34 exceeds the second threshold (e.g., ninety percent of maximum capacity), an unavailability notification is generated by the resource 34 and transmitted from that resource 34 to the resource allocators 32 to which the resource is assigned. If the resource 34 is in a state where it is not accepting more work (i.e., unavailable), and the characteristic of the resource 34 falls below the first threshold (e.g., eight percent of maximum capacity), an availability notification is generated by the resource 34 and transmitted from that resource 34 to the resource allocators 32 to which the resource 34 is assigned.

The resource allocators 32 allocate work based upon the availability and unavailability notifications received from the resources 34. For example, the resource allocators 32 may assign work to the available resources 34 based upon a round robin selection scheme and will not assign work to the unavailable resources 34. Further, in one embodiment, the resource allocators 32 maintain, for example in a table or list in memory, an availability indication or indicator (e.g., available or unavailable flag) for each of the resources 34 assigned to that resource allocator 32. The availability indication or indicator is updated when a new notification is received from any of the resources 34 assigned to that resource allocator 32.

Additionally, in one embodiment, when the resource 34 transmits an availability or unavailability notification to a resource allocator 32, the resource 34 establishes a communication path between itself and all the resource allocators 32 to which it is assigned. These communications paths may be set up, for example, through system management software, dynamically by the resource allocators 32, by the resources 34, or by any other suitable means. Specifically, and in one embodiment, in an initial message exchange when the communication path is first established, the resource 34 indicates to the resource allocator 32 whether the resource 34 is available or unavailable. Further, when the communications path is first established from a resource 34 to a resource allocator 32, the resource allocator 32 can add the resource 34 into the list of potential resources 34 assigned to that resource allocator 32. The list may be used in associating an availability indication or indicator with a particular resource 34.

As an example of one exemplary implementation of an embodiment of the present invention, a description of a call processing system will now be described. A call processing system is typically designed using a multi-processing configuration. An incoming call can be assigned to any processor in the system, such that each processor generally executes the same software program. The system attempts to distribute new incoming calls across all the processors available in the system to process the calls. One processor serving as the control processor in the system is designed with software that assigns calls to the available system processors. If the control processor fails, the system is unable to process new calls. Thus, in many systems, the control processor is replicated, such that two or more control processors provide the call assignment function.

Various embodiments of the present invention as described herein allow the call assignment programs (i.e., the resource allocators 32) at the control processors to distribute the call load that each receives or recognizes to the set of available call processors (i.e., the resources 34) based upon availability notifications received from the call processors. This results in use of nearly all the communication bandwidth in the system and all the central processing unit (CPU) cycles available to the call assignment program for the purpose of assigning and processing calls because minimal processor or communication bandwidth needs to be used to coordinate the call assignment programs and call processing programs.

As an example of another exemplary implementation of an embodiment of the present invention, a wireless communication system or network will now be described. A wireless communication system includes many base stations, each of which provides radio frequency (RF) coverage for some geographical area. The system architecture in wireless standards and employed in most, if not all wireless system implementations, direct subsets of the base stations onto control points (e.g., processing resources 34) in the network. These control points are used to control assignment of resources 34 within the wireless communication system, for example, when handling wireless calls within that system. These control points may be located, for example, at a centralized data center for allocating wireless calls across the wireless communication system. Further, the control points may be a plurality of control programs that operate to control the assignment of resources 34 (e.g., allocation of computing resources), and more particularly, to determine and select specific resources for use in processing wireless calls. Thus, these control points are connected into a large core network that serves to interconnect a wireless user with a Public Switched Telephone Network (PSTN) and to provide mobility and other services.

More particularly, a typical wireless communication system provides wireless communications service to a number of wireless or mobile units within a geographic region. The geographic region serviced by a wireless communication system is divided into spatially distinct areas called “cells.” A conventional cellular system comprises a number of cell sites or base stations geographically distributed to support transmission and receipt of communication signals to and from the wireless units. Each cell site handles voice communications over a cell, and the overall coverage area for the cellular system is defined by the union of cells for all of the cell sites, where the coverage areas for nearby cell sites overlap to some degree to ensure (if possible) contiguous communications coverage within the outer boundaries of the system's coverage area. One cell site may sometimes provide coverage for several sectors.

A base station comprises the radios and antennas that the base station uses to communicate with the wireless units in that cell and also comprises the transmission equipment that the base station uses to communicate with a Mobile Switching Center (MSC). The MSC is responsible for, among other things, establishing and maintaining calls between the wireless units, between a wireless unit and a wireline unit via a PSTN or between a wireless unit and a packet data network (PDN), such as the Internet. It should be noted that a base station controller (BSC) can be a separate or connected to several base stations or a base station controller located at each base station, which administers the radio resources for the base stations and relays information to the MSC.

When active, a mobile unit receives forward link signals from and transmits reverse link signals to (at least) one cell site or base station. Each active mobile unit is assigned a forward link on which it receives its forward link signals on at least one forward link channel and a reverse link on which it transmits reverse link signals on at least one reverse link channel. There are many different schemes for defining forward and reverse link channels for a cellular telephone system, including TDMA (time-division multiple access), FDMA (frequency-division multiple access), and CDMA (code-division multiple access) schemes. In CDMA communications, different channels are distinguished by different spreading sequences that are used to encode different information streams, which may then be modulated at one or more different carrier frequencies for simultaneous transmission. A receiver can recover a particular information stream from a received signal using the appropriate spreading sequence to decode the received signal.

In operation, when a wireless user is called, the core network determines the geographic area in which the user is located and sends call setup information to the control point of the base station that covers the desired geographic area. When calls are originated by a wireless user, the base station passes its call setup information to its control point. Various embodiments of the present invention as described herein allow the core network or BSCs (i.e., the resource allocators 32) to allocate processing of the calls to the control points (i.e., the resources 34) based upon availability notifications received from the control points, such that the capacity of the set of control points that are controlled by the core network or base station controllers may be increased. Thus, the set of control points in the wireless communication system may be used as resources 34 by either the core network components or by the set of base stations without incurring large overhead penalties (e.g., use of bandwidth) in communication or processing cycles typically needed to keep each set of assignment entities (i.e., resources allocators 32) synchronized in the use of the control point resources 34.

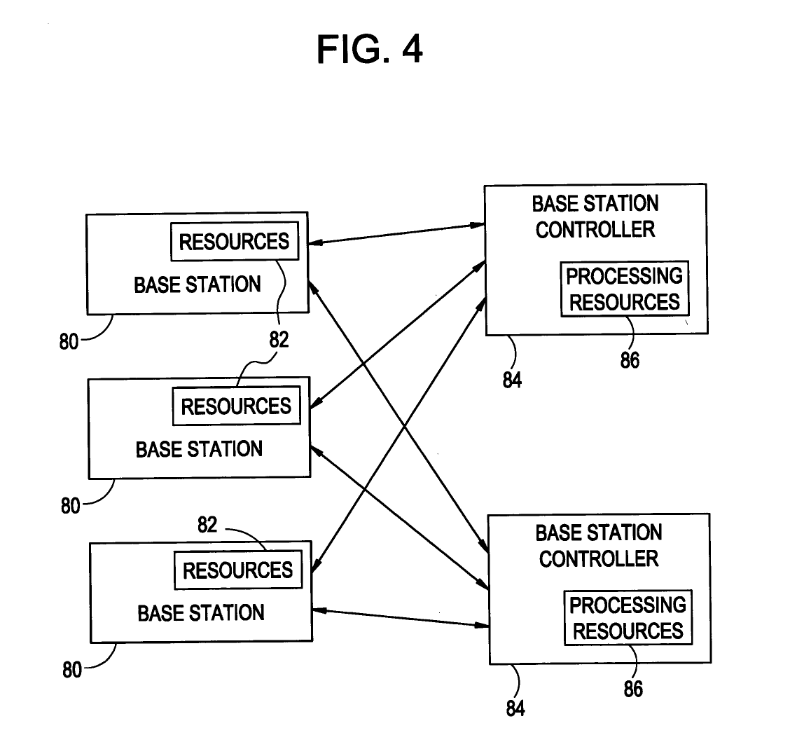

Specifically, and for example as shown in FIG. 4, each base station 80 may have associated therewith a set of resources 82 for processing call information from the wireless users within the network. Further, each base station 80 may be associated with one or more BSCs 84. The base station 80 operates as a resource allocator to allocate wireless calls from users within the network to specific BSCs 84 that are the resources. The BSCs 84 are also resource allocators for their own processing resources 86. Thus, the set of resources 82 provide availability notifications to their base station 80 (i.e., resource allocator) for use by the base station 80 to allocate use of the set or resources 82 to communicate with wireless uses. Further, the BSCs 84 (i.e., resources) provide availability notifications to the base stations 80 (i.e., resource allocator) for use by the base stations 80 in assigning wireless calls for processing to available BSCs 84.

The BSCs 84 also operate as resource allocators with respect to a set of processing resources 86 within the BSC 84 for processing the call information for the wireless calls from the base stations 80. The set of processing resources 86 within the BSC 84 provide availability notifications to their BSC 84 (i.e., resource allocator) for use by the BSC 84 allocate use of the resources 86 for processing the call information. Thus, resources at different levels within the wireless system may be allocated based upon availability notifications generated according to various embodiments of the present invention.

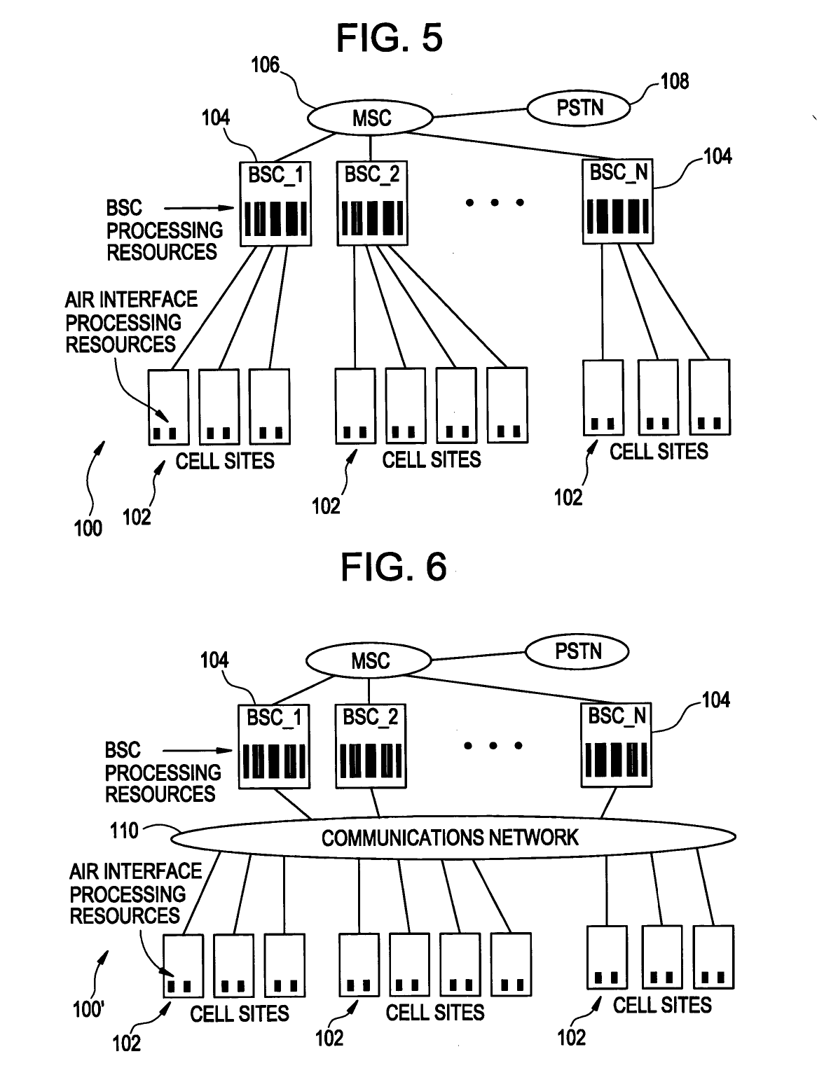

As another wireless communication example, and as shown in FIG. 5, a wireless network 100 includes a set of cell sites 102 (e.g., plurality of base stations) that provide a means for wireless users to send over-the-air transmissions to the wireless infrastructure. In particular, each cell site 102 communicates over one or more land line facilities to a control point such as a BSC 104. The BSC 104 provides processing control of a wireless user's call and provides a means of connecting the user's data stream (e.g., voice information) to a MSC 106 and then to a PSTN 108. Each portion or level of the wireless network 100 includes a set of resources necessary to provide wireless service to the wireless user and in connection with which various embodiments of the present invention may be implemented.

Specifically, one or more computer control programs in each network component (e.g., cell site 102 or BSC 104) controls the resources provided by that component. For example, within the BSC 104 there may be a set of computing resources that provide processing needed to manage the information stream coming from a mobile terminal or being sent to a mobile terminal. In general, numerous computing resources are required to handle the call load presented by the set of cell sites 102 (e.g., base stations) connected to the BSC 104. In operation, when an incoming call is presented to a control program of a BSC 104, the control program allocates one of its available processing resources to process the call information using the various embodiments of the present invention. Further, and at a different level in the wireless network 100, within the cell sites 102, for example base stations, there is generally another computer program that allocates one of its resources that converts the user information stream from the format used to communicate the information over a land line facility to a format used to communicate the information over the air interface with the mobile terminal. This allocation of resources may also be provided using the various embodiments of the present invention.

In the wireless network 100 shown in FIG. 5, each cell site 102, as determined by its initial configuration, is controlled by only one BSC 104, and the cell site 102, therefore, communicates only with that BSC 104 to establish, release, or otherwise process a call. It should be noted that numerous processing resources may reside within the BSC 104 as described above. Also, to provide resiliency against faults in the allocation program and in the processor that runs the allocation program, there may be more than one resource allocation processor and program provided. When multiple resources allocation processors and programs are provided, the various embodiments of the present invention can be used to provide an effective, efficient resource allocation scheme to handle wireless calls. Further, in the cell sites 102, replicated resource allocator programs that run on more than one processor to assign the air interface processing resources within the cell site 102 may be provided. Various embodiments of the present invention when implemented in a system having replicated resource allocator programs within the cell sites 102 can provide an efficient resource allocation design with redundancy.

Referring now to FIG. 6, and another wireless communication example, a wireless network 100′ includes cell sites 102 that are not pre-configured to be controlled by any specific BSC 104. In this wireless network 100′, each cell site 102 is connected via a communications network 110 (e.g., an IP network) with a means of communicating with any BSC 104 in the wireless network 100′. In operation, when a call establishment request arrives from a mobile user, the control program in the cell site 102 operates such that the plurality of BSCs 104 are a set of resources, and the cell site 102 selects one of the BSCs 104 (i.e., allocates processing to one BSC 104) to operate as the overall controller of the specific call, for example, using the various embodiments of the present invention. When another call establishment request arrives, the control program in the cell site 102 can select (i.e., allocate) a different BSC 104 to operate as the overall controller of that call based upon the various embodiments of the present invention. In this manner, the calls assigned or allocated through a specific cell site 102 may be spread across the set of available BSCs 104 based upon availability notifications according to the various embodiments of the present invention. The calls through all the cell sites 102 likewise may be spread across the set of available BSCs 104 based upon availability notifications according to the various embodiments of the present invention.

Such an implementation may increase the resiliency of the wireless network 100′ as a whole, because each cell site 102 is not dependent on any specific BSC 104 to handle its calls. Also, and for example, the BSCs 104 can have a lower reliability, for example, than those in the wireless network 100 shown in FIG. 5, as a result of the availability of a plurality of BSCs 104 to process calls from the cell sites 102.

Further, the computing resources within each BSC 104 in the wireless network 100′ are controlled by the allocation control of the BSC 104 call processors and various embodiments of the present invention for resource allocation may be implemented within the BSC 104 to control its call processors. Further, allocation control of the air interface processing resources within each cell site 102 are controlled by the cell site 102 control programs, which may be provided by the various embodiments of the present invention. In the wireless network 100′, unlike in the wireless network 100, the BSCs 104 are a set of assignable resources that may be assigned by the control programs within each cell site 102.

Thus, various embodiments of the present invention eliminate the need for resource allocators 32 to keep track of, for example, the precise number of jobs currently assigned to any of the resources 34. Further, a given resource allocator 32 does not need to know what jobs or operations have been allocated by another resource allocator 32 to the resources 34. The resource allocators 32 do not communicate between each other with respect to allocation of use of the resources 34. Each resource allocator 32 is independent of the others, such that when a resource allocator 32 is first brought online, it communicates with the set of resources 34 as described herein and begins to allocate use of the available set of resources 34 without the need to identify the allocation actions of other resource allocators 32. Thus, the only communication in the system 30, 30′, 30″ relating to resource usage are the notifications transmitted by the resources 34 to the resource allocators 32 when (i) there is a first communication between a resource 34 and a resource allocator 32 to establish their communication path and (b) when a characteristic of a resource falls below or exceeds a threshold. Further, the communication of these notifications is sent relatively infrequently, and therefore, the resource allocators 32 do not consume undue processing and communication bandwidth to exchange resource utilization information. Additionally, the determination by each of the resources 34 as to its availability or unavailability need not be the same for all resources 34, thereby making it easier to add resources 34 to a system or network.

Further, simplicity of design, reduction of communications otherwise required to manage resource assignment, removal of the need to have the resource allocators 32 (e.g., assignment programs) communicate for the purpose of coordinating their assignment activities, and simpler recovery actions when a resource allocator 32 fails or when a new resource allocator 32 is brought online are provided. No processing cycles are consumed on the resource allocators 32 for the purposes of tracking utilization of the available resources 34, nor is communication bandwidth used in the system for the purpose of synchronizing the set of resource allocators 32 with respect to the utilization of the resources 32 to which work is being assigned.

It should be understood that different notations, references and characterizations of the various architecture components can be used. For example, the system and portions thereof and of described wireless communication systems herein can be implemented by processing circuitry in different locations within the wireless unit and/or the wireless communications system, such as the wireless unit, the base station(s), the BSCs and/or MSC(s). Moreover, logic or hardware required to implement the various embodiments of the present invention may be implemented in application specific integrated circuits, software-driven processing circuitry, firmware, programmable logic devices, hardware, discrete components or arrangements of the above components or processing circuitry as would be understood by one of ordinary skill in the art with the benefit of this disclosure.

The description of the various embodiments of the present invention is merely exemplary in nature and, thus, variations that do not depart from the gist of the embodiments are intended to be within the scope of the invention. Such variations are not to be regarded as a departure from the spirit and scope of the various embodiments of the invention.

What is claimed is:

1. A method for resource availability notification comprising:
first generating a notification of resource availability based on a characteristic of the resource.

2. The method of claim 1, wherein the characteristic is one of resource occupancy, memory occupancy, delay and bandwidth usage.

3. The method of claim 1, further comprising:
comparing the characteristic to a first threshold; and
wherein the first generating step for generating a notification of resource availability is based on results of the comparison.

4. The method of claim 3, further comprising:
determining when the characteristic falls below the first threshold based upon the comparison; and
wherein the first generating step generates the availability notification in response to the determination.

5. The method of claim 4, wherein the characteristic is one of resource occupancy, memory occupancy, delay and bandwidth usage.

6. The method of claim 3, further comprising:
second generating notification of resource unavailability based on a comparison of the characteristic to a second threshold.

7. The method of claim 6, further comprising:
first determining when the characteristic falls below the first threshold;
second determining when the characteristic exceeds the second threshold; and
wherein the first generating step generates the availability notification in response to the first determination and the second generating step generates the unavailability notification in response to the second determination.

8. The method of claim 7, wherein the characteristic is one of resource occupancy, memory occupancy, delay and bandwidth usage.

9. The method of claim 6, wherein the second threshold is different from the second threshold for another resource.

10. The method of claim 3, wherein the first threshold is different from the first threshold for another resource.

11. The method of claim 1, wherein the characteristic is different from the characteristic for another resource.

12. A method for allocating use of resources in a system, the method comprising:
allocating use of a plurality of resources based upon a notification received from one or more of the plurality of resources of an availability of the one or more resources.

13. The method of claim 12, wherein the step of allocating further comprises:
assigning different resources to perform operations based upon availability.

14. The method of claim 12, wherein the availability is based on a characteristic of the resource.

15. The method of claim 14, wherein the characteristic is one of resource occupancy, memory occupancy, delay and bandwidth usage.

16. The method of claim 14, further comprising:
establishing a first threshold for each of the plurality of resources; and
wherein the availability notification is based on a comparison of the characteristic to the first threshold.

17. The method of claim 16, further comprising:
establishing a second threshold for each of the plurality of resources; and
wherein the availability notification is based on a comparison of the characteristic to the second threshold.

18. The method of claim 17, wherein the characteristic is one of resource occupancy, memory occupancy, delay and bandwidth usage.

19. The method of claim 17, wherein the first and second thresholds are different for one or more of the plurality of resources.

20. The method of claim 14, wherein the characteristic is different for one or more of the plurality of resources.

21. The method of claim 12, further comprising:
storing an availability indication for each notification received from one or more of the plurality of resources.

22. A method for allocating use of resources in a system, the method comprising:
allocating use of a plurality of resources using a plurality of resource allocators, the plurality or resource allocators operating independent of each other.

23. The method according to claim 22, wherein each of the plurality of resource allocators allocate use of one or more of the plurality of resources without communicating with other ones of the plurality of resource allocators.
